(19) United States
(12) Patent Application Publication
(10) Pub. No.: US 2005/0182747 A1
(43) Pub. Date: Aug. 18, 2005

(54) Method and system for executing multiple tasks at adaptively controlled resource utilization rates to achieve equal QoS levels

(76) Inventors: Yukikazu Nakamoto, Tokyo (JP); Toshimitsu Ushio, Osaka (JP); Fumiko Harada, Osaka (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/038,690

(22) Filed: Jan. 21, 2005

(30) Foreign Application Priority Data
Feb. 18, 2004 (JP) 2004-040722

(51) Int. Cl. G06F 7/00

(52) U.S. Cl. 707/1

(57) ABSTRACT

The QoS levels of multiple tasks are maintained at equal levels by executing items of the tasks stored in a queue during a given time interval at respectively adaptively controlled CPU utilization rates. The QoS levels of the executed items are detected and evaluated. The CPU utilization rates are updated with respective differences between a target value and the evaluated QoS levels. A difference is detected between each of the evaluated QoS levels obtained during a previous time interval and each of the evaluated QoS levels obtained during a current time interval and the detected difference is compared to a predetermined value. During a subsequent time interval, the previously stored items of the queue are replaced with new items of the tasks if the difference is smaller than the predetermined value and the previously stored items are executed again with the updated CPU utilization rates if the difference is greater than predetermined value.

### BACKGROUND OF THE INVENTION

### Field of the Invention

The present invention relates to a multitasking computer system and more specifically to a system where the QoS (Quality-of-Service) levels of tasks are maintained at equal values by adaptively controlling resource (CPU) utilization rates individually for the tasks.

Research has been made in the past on the subject of negotiating QoS levels of multiple tasks and several technical papers have been published. For example, “QoS Negotiation in Real-time systems and Its Application to Automated Flight Control”, (T. Abdelzaher, E. Atkins and K. Shin, Proc. IEEE Real-Time Technology and Application Symposium, 1997) describes a real-time system in which acceptable levels of QoS are defined in advance for respective tasks under an overloaded system condition and based on the defined QoS levels, negotiation is performed among the tasks when the system is overloaded.

“Adaptive Workload Management through Elastic Scheduling” (G. Buttazzo and L. Abeni, Real-Time Systems, Vol. 23, No. 1, pp. 7-24, 2002) describes a real-time system in which the concept of an elastic model is introduced. In the elastic model concept, task processing is treated as a spring-like elastic entity. When the system is approaching an overloaded condition, the execution time of each task is compressed to prevent the system from being overloaded. Accordingly, an application program must be designed with an elastic model in mind, which is however not easy to achieve.

“A Resource Allocation Model for QoS Management” (R. Rajkumar, C. Lee, J. Leoczky and D. Siewiorek, Proc. 18th IEEE Real-Time System Symposium, pp. 298-307, December 1997) proposes a QoS-based resource allocation model based on QoS when simultaneously accessing a plurality of resources. According to the allocation model, an algorithm is proposed that maximizes the QoS levels of multiple application programs by imposing constraints that the lower limit of the QoS level requested for each application program must be met.

“Portable RK: A Portable Resource Kernel for Guaranteed and Enforced Timing Behavior” (S. Oikawa and R. Rajkumar, Proc. of the IEEE Real-Time Technology and Applications Symposium, June 1999) proposes a software architecture and a resource reservation application programnuing interface (API) to guarantee the temporal QoS level of a real-time program for developing an admission-controlled portable kernel module.

Another research that is currently attracting attentions is the application of control theory to the real-time system. For example, “A Feedback-driven Proportional Allocator for Real-Rate Scheduling” (D. Steere, A. Goel, J. Greunberg, D. McNamee, C. Pu and J. Walpole, Proc. of the 3 rd symposium on Operating Systems Design and Implementation, 1999) describes a system in which PID (proportional-integral-derivative) control algorithm is used in managing the CPU utilization rates of multiple tasks. Since the PID control algorithm is dynamic in nature, past records of the CPU utilization rates must be maintained.

A further research relates to the use of a PI feedback control theory for controlling the CPU utilization rates of multiple tasks and their deadline-miss rates at specified values as proposed in “Analysis of a Reservation-Based Feedback Scheduler” (L. Abeni, L. Palopoli, G. Lipari and J. Walpole, Proc. of the 23rd Real-Time Systems Symposium, pp. 71-80, 2002). Additionally, “Feedback Control Real-Time Scheduling: Framework, Modeling, and Algorithms” (C. Lu, J. Stankovic, S. Son and G. Tao, Real-Time Systems, Vol. 23, No. 1, pp. 85-126, 2002) describes another technique in which target values are given to the CPU utilization rates and deadline-miss rates in a gain-feedback system.

In the prior art techniques target values must be calculated in advance.

However, the target values depend on a set of multiple tasks to be executed. If the multiple tasks that form a set vary with time, the target values must be recalculated. Since nonlinear equations are involved in this recalculation, the recalculation would amount to O(n²) if the number of tasks is equal to “n”.

When a real-time system is operating under an overloaded condition, it is necessary to avoid deadline-miss by lowering the CPU utilization rates of multiple tasks. Usually, the QoS levels of the tasks are represented by the nonlinear function of the mutually different CPU utilization rates and hence the QoS levels vary differently for each task if the CPU utilization rates are equally controlled.

### SUMMARY OF THE INVENTION

It is therefore an object of the present invention to provide a method and system for maintaining the QoS levels of multiple tasks at equal levels by executing task items at adaptively controlled resource utilization rates derived respectively from the QoS levels of the executed task items, while avoiding overload conditions.

According to a first aspect of the present invention, there is provided a method of controlling QoS levels of a plurality of tasks, comprising the steps:
a) during a time interval, storing items of the tasks in a queue,
b) executing the items at respective resource utilization rates,
c) detecting QoS levels of the executed items,
d) evaluating the detected QoS levels of the executed items,
e) updating the resource utilization rates with respective differences between a target value and the evaluated QoS levels,
f) determining, from the evaluated QoS levels, whether the detected QoS levels are converging to the target value or diverging from the target value, and
g) during a subsequent time interval, replacing the previously stored items of the queue with new items of the tasks and repeating steps (b) to (f) on the new items if the QoS levels are converging to the target value, and repeating steps (b) to (f) on the previously stored items if QoS levels are diverging from the target value.

In a preferred embodiment, the difference between each of the evaluated QoS levels obtained during a previous time interval and each of the evaluated QoS levels obtained during a most recent time interval is detected and compared to a predetermined value. During the next time interval, if the difference is smaller than the predetermined value, the previously stored items of the queue are replaced with new items of the tasks and steps (b) to (f) are repeated on the new items, and if the difference is greater than the predetermined value steps (b) to (f) are repeated on the previously stored items.

According to a second aspect, there is provided a computer system having a plurality of tasks. The computer system comprises a queue for holding a plurality of items of the tasks during a time interval, a first memory for storing resource utilization rates associated respectively with the stored items, means for executing the items at the associated resource utilization rates respectively, and a second memory. Adaptive control mechanism is provided for detecting QoS levels of the executed items, evaluating the detected QoS levels of the executed items, and updating the resource utilization rates of the first memory with respective differences between a target value and the evaluated QoS levels. Decision mechanism determines, from the evaluated QoS levels, whether the detected QoS levels are converging to the target value or diverging from the target value, and replaces the stored items of the queue with new items of the tasks if the evaluated QoS levels are converging to the target value, and causing the previously stored items to be executed again by the executing means if the evaluated QoS levels are diverging from the target value.

According to a third aspect of the present invention, there is provided a computer-readable storage medium containing a program for controlling QoS levels of a plurality of tasks, comprising the steps:
a) during a time interval, storing items of the tasks in a queue,
b) executing the items at respective resource utilization rates,
c) detecting QoS levels of the executed items,
d) evaluating the detected QoS levels of the executed items,
e) updating the resource utilization rates with respective differences between a target value and the evaluated QoS levels,
f) determining, from the evaluated QoS levels, whether the detected QoS levels are converging to said target value or diverging from said target value; and
g) during a subsequent time interval, replacing the previously stored items of the queue with new items of the tasks and repeating steps (b) to (f) on the new items if the QoS levels are converging to said target value, and repeating steps (b) to (f) on the previously stored items if QoS levels are diverging from said target value.

### BRIEF DESCRIPTION OF THE DRAWINGS

The present invention will be described in detail further with reference to the following drawings, in which:

FIG. 1 is a block diagram of a computer system in which CPU utilization rates of all tasks are adaptively controlled according to the present invention so that the QoS levels of the tasks are maintained equally at a target value and illustrates the status of memories at the start of a given time interval in which the utilization rates are calculated for the next time interval;

FIGS. 2A and 2B are flowcharts of the operation of the computer system; and

FIG. 3 is a block diagram of the computer system which illustrates the status of the memories at the end of the given time interval for producing a command signal for the next time interval.

### DETAILED DESCRIPTION

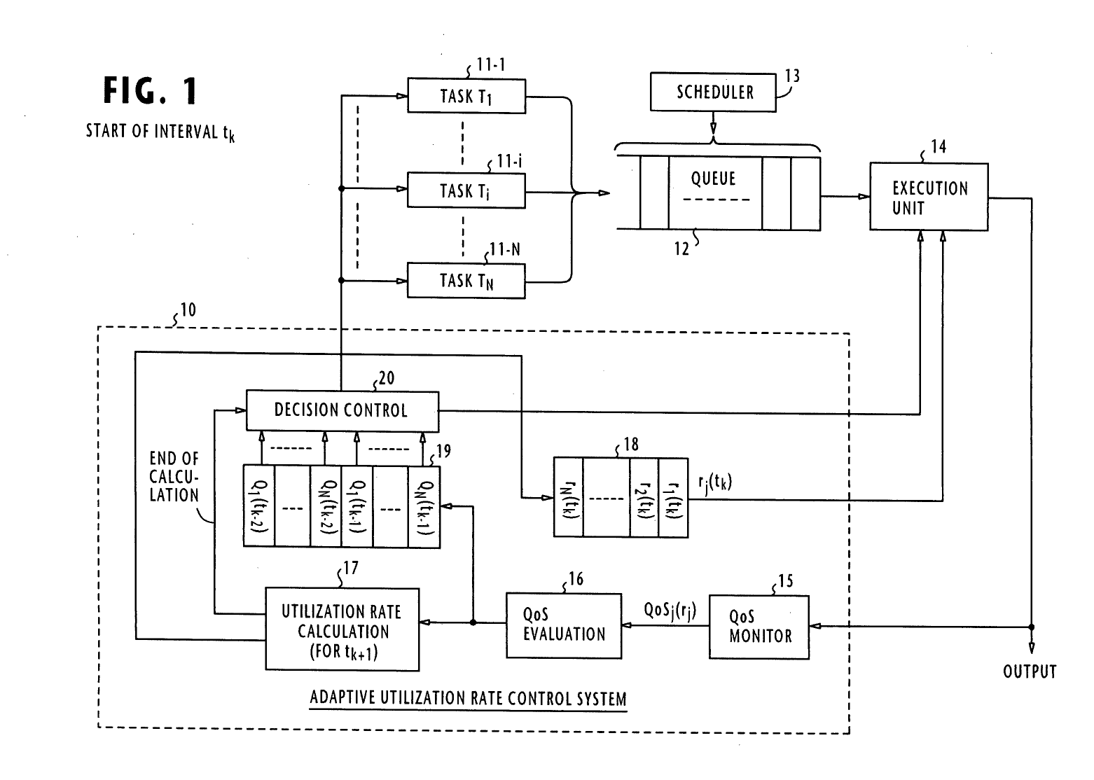

Referring to FIG. 1, an exemplary computer system of the present invention is illustrated. The system executes a plurality of tasks T₁ through T_{N}, indicated by numerals 11-1˜11-N, at equal QoS levels by adaptive control of utilization rates of a CPU, which are respectively determined when the tasks are executed by the execution unit 14 of the CPU. Each of the tasks 11 forwards a service item to be executed to a queue 12. The service item includes a temporal entity such as jobs and a spatial entity such as memory space and the Operating System. The service items stored in the queue 12 are delivered to the execution unit 14 in an order determined by a scheduler 13. In a real-time system, the scheduler 13 performs the scheduling of queued service items according to a known scheduling policy, such as the Rate Monotonic Scheduling that reads the stored items in a descending order of intervals at which the tasks are periodically executed, or the Earliest Deadline First Scheduling that reads the stored items in a descending order of deadlines.

The task Tᵢ of the service item reordered by the scheduler 13 is identified by Tⱼ. At the start of a time interval tₖ, resource utilization rates r₁(tₖ) through r_{N}(tₖ) are stored in a memory 18, which were calculated corresponding to the tasks during the previous time interval tₖ₋₁ and tₖ. Execution unit 14 begins to read the service item of a task Tⱼ delivered from the queue 12 and the value of a resource utilization rate rⱼ(tₖ) from the memory 18 and executes the read service item at the resource utilization rate rⱼ(tₖ).

To the output of the execution unit 14 is provided an adaptive utilization rate controller 10, which includes a QoS monitor 15 which monitors the executed service item for detecting its QoS level represented by QoSⱼ(rⱼ(tₖ)). As described in detail later, the QoS level of each executed item is then subjected to QoS evaluation process 16, which evaluates the QoS level of a task and produces an evaluation output Qⱼ(tₖ).

The evaluation output Qⱼ(tₖ) is stored in a memory 19. At the start of time interval tₖ, the memory 19 is storing the evaluation outputs Q₁(tₖ₋₂)˜Q_{N}(tₖ₋₂) and Q₁(tₖ₋₁)˜Q_{N}(tₖ₋₁). The output of QoS evaluation 16 is used in an adaptive utilization rate calculation process 17. Based on an adaptive control algorithm the calculation process 17 initially produces an average value of the current evaluation outputs Q₁(tₖ)˜Q_{N}(tₖ) and uses this average value as a target value to sequentially produce resource utilization rates r₁(tₖ₊₁) through r_{N}(tₖ₊₁) to be used during the next time interval.

In response to an end-of-calculation command from the utilization rate calculation 17, the decision control 20 reads evaluation data from the memory 19 and calculates the absolute value of the difference between the current and previous values of QoS evaluation and compares this absolute value to a predetermined error value. If the absolute difference value is smaller than the error value, the decision control 20 supplies a proceed-to-next command to the tasks 11 so that, during the next interval tₖ and tₖ₊₁ the next service items are executed at the utilization rates r₁(tₖ₊₁)˜r_{N}(tₖ₊₁), respectively. If the absolute difference value is greater than the error value, the decision control supplies a repeat command to the execution unit 14 to execute the same service items stored in the queue 12, using the utilization rates r₁(tₖ₊₁)˜r_{N}(tₖ₊₁), instead of the utilization rates r₁(tₖ)˜r_{N}(tₖ).

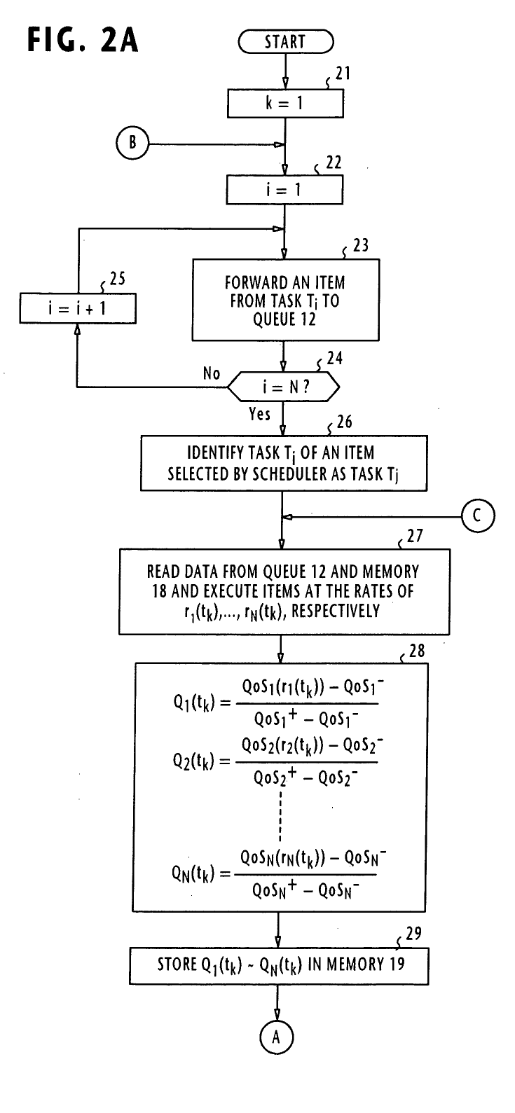

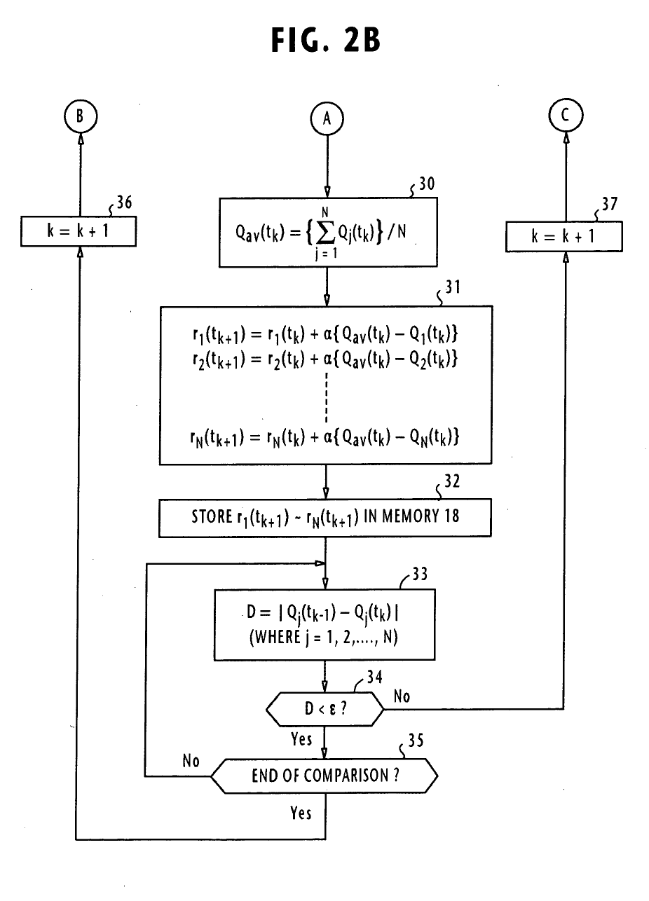

Details of the present invention will be best understood by the following description with reference to flowcharts shown in FIGS. 2A and 2B.

In FIG. 2A, the operation of the computer system begins with step 21 by setting a timing indicator k to 1 and setting a non-scheduled task indicator i to 1 (step 22). At step 23, one of the tasks 11-1 through 11-N, or task Tᵢ forwards a service item to the queue 12 and flow proceeds to decision step 24. If the task indicator i is not equal to N, the decision is negative at step 24 and the indicator i is incremented by 1 at step 25 and flow returns to step 23.

By repeating steps 23 to 25, all tasks forward their items to the queue 12, and the decision at step 24 is affirmative. Scheduler 13 reorders the stored items in a manner as described previously. The computer system now proceeds from step 24 to step 26 to identify the task Tᵢ of the selected item as Tⱼ. At step 27, the execution unit 14 reads data from the queue 12 and the memory 18 and executes the read service items at the resource utilization rates r₁(tₖ), r₂(tₖ), . . . , r_{N}(tₖ) of the task T₁, T₂, T_{N}, respectively.

QoS monitor 15 monitors the executed service items for detecting their QoS levels and produces QoS outputs indicated by QoS₁(r₁(tₖ)), QoS₂(r₂(tₖ)), . . . , QoS_{N}(r_{N}(tₖ)).

At step 28, QoS evaluation is performed on each of the outputs QoS₁(r₁(tₖ))˜QoS_{N}(r_{N}(tₖ)). This is done by initially setting an upper limit QoSⱼ⁺ of the QoS level which will be obtained if the task is executed at the maximum resource utilization rate rⱼ⁺ and setting a lower limit QoSⱼ⁻ of the QoS level which will be obtained if the task is executed at the minimum resource utilization rate rⱼ⁻. The following equation is then calculated for all the executed tasks:

$${Q}_{j} ( {t}_{k} ) = \frac{{QoS}_{j} ( {r}_{j} ( {t}_{k} ) ) - {QoS}_{j}^{-}}{{QoS}_{j}^{+} - {QoS}_{j}^{-}} \qquad ( 1 )$$

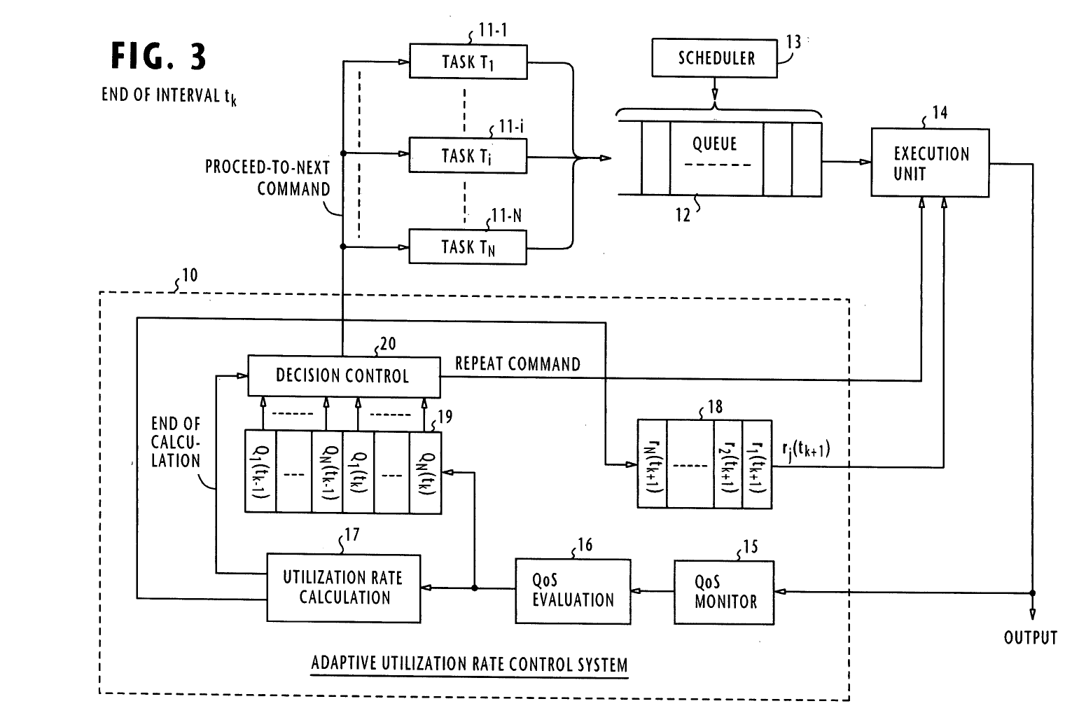

Equation (1) indicates that, for a given task Tⱼ, when Qⱼ(tₖ) equals 1 the utilization rate is maximum and when Qⱼ(tₖ) equals 0 the utilization rate is minimum. Since the QoS level of task Tⱼ lies in the range between QoSⱼ⁻ and QoSⱼ⁺, it can be considered that Qⱼ(tₖ) represents the best QoS level that can be achieved for the task Tⱼ. The evaluation values Q₁(tₖ), Q₂(tₖ), . . . , Q_{N}(tₖ) are stored in the memory 19 (step 29) and supplied to adaptive utilization rate calculation 17, and flow proceeds to step 30 (FIG. 2B). As a result, in the memory 19, a first set of QoS evaluation values Q₁(tₖ₋₁), Q₂(tₖ₋₁), . . . Q_{N}(tₖ₋₁) and a second set of QoS evaluation values Q₁(tₖ), Q₂(tₖ), . . . , Q_{N}(tₖ) are stored as shown in FIG. 3.

Adaptive utilization rate calculation 17 calculates an average value Qₐᵥ(tₖ) of the evaluation values Qⱼ(tₖ) as follows:

$${Q}_{av} ( {t}_{k} ) = \{ {\sum }_{j = 1}^{N} {Q}_{j} ( {t}_{k} ) \} / N \qquad ( 2 )$$

At step 31, the following equation is calculated for all tasks:
rⱼ(tₖ₊₁)=rⱼ(tₖ)+α{Qₐᵥ(tₖ)−Qⱼ(tₖ)} (3)
where, α represents a common feedback gain and j=1, 2, . . . , N. Using the average value Qₐᵥ(tₖ) as a reference target value, the current utilization rate rⱼ(tₖ) is updated with the weighted value of a difference between Qₐᵥ(tₖ) and Qⱼ(tₖ) and the updated resource utilization rates r₁(tₖ₊₁), r₂(tₖ₊₁), . . . , r_{N}(tₖ₊₁) are stored in the memory 18 (step 32) as shown in FIG. 3. By performing a feedback control on the next service items, the difference between Qₐᵥ(tₖ) and Qⱼ(tₖ) will be reduced toward zero.

At step 33, decision control 20 read data from the memory 19 (FIG. 3) and calculates the absolute value of a difference value D between each of the previous evaluation values Qⱼ(tₖ₋₁) and a corresponding current evaluation value Qⱼ(tₖ) and compares the absolute difference D to a predetermined error value e (step 34). If the difference value |Qⱼ(tₖ₋₁)˜Qⱼ(tₖ)| is smaller than the error value e, steps 33 to 35 are repeated. If the decision at step 35 is affirmative, it is determined that the QoS levels of all tasks will converge to the average value that lies between the minimum QoS⁻ and the maximum QoS⁺ and flow proceeds to step 36 to increment the timing indicator k by 1 and returns to step 22, whereupon the decision control 20 supplies a proceed-to-next command to all the tasks so that the next service items can be executed at the updated resource utilization rates during the next time interval.

If the difference |Qⱼ(tₖ₋₁)−Qⱼ(tₖ)| is greater than the error value ε for at least one task (step 34), it is determined that the QoS levels of all tasks will not converge to the average value, and flow proceeds to step 37 to increment the timing indicator k by 1 and returns to step 27 to repeat the execution of the same service items using the updated resource utilization rates r₁(tₖ₊₁), r₂(tₖ₊₁), r_{N}(tₖ₊₁) during the next time interval.

In this way, the resource utilization rates r₁(tₖ) through r_{N}(tₖ) of all tasks are adaptively controlled so that the following relation holds:
Q₁(tₖ)=Q₂(tₖ)=Q₃(tₖ) . . . , =Q_{N}(tₖ) (4)

When Equation (4) is established, it is considered that resource utilization rates respectively used for executing the tasks are commensurate with the task loads on the CPU.

As a result, if the difference between the evaluated QoS levels Qⱼ(tₖ₋₁) and Qⱼ(tₖ) is smaller than the error value, the items stored during a previous time interval are replaced with new items of the tasks in the queue 12 during a subsequent time interval, and the new item are executed at the updated resource utilization rates respectively. If the difference between Qⱼ(tₖ₋₁) and Qⱼ(tₖ) is greater than the error value, the items stored during the previous time interval are not replaced with new items during a subsequent time interval and executed again, this time, with the resource utilization rates that are updated for the next items.

1. A method of controlling QoS levels of a plurality of tasks, comprising the steps:
a) during a time interval, storing items of the tasks in a queue;
b) executing the items at respective resource utilization rates;
c) detecting QoS levels of the executed items;
d) evaluating the detected QoS levels of the executed items;
e) updating the resource utilization rates with respective differences between a target value and the evaluated QoS levels;
f) determining, from the evaluated QoS levels, whether the detected QoS levels are converging to said target value or diverging from said target value; and
g) during a subsequent time interval, replacing the previously stored items of the queue with new items of the tasks and repeating steps (b) to (f) on the new items if the QoS levels are converging to said target value, and repeating steps (b) to (f) on the previously stored items if QoS levels are diverging from said target value.

2. The method of claim 1, wherein step (f) comprises the steps of:
detecting a difference between each of the evaluated QoS levels obtained during a previous time interval and each of the evaluated QoS levels obtained during a most recent time interval; and
comparing the detected difference to a predetermined value, wherein step (g) comprises the steps of:
during said subsequent time interval, replacing the previously stored items of the queue with new items of the tasks and repeating steps (b) to (f) on the new items if the difference is smaller than the predetermined value, and repeating steps (b) to (f) on the previously stored items if the difference is greater than the predetermined value.

3. The method of claim 1, wherein step (d) comprises the steps of:
d₁) detecting differences between the detected QoS levels and a QoS lower limit;
d₂) detecting a difference between a QoS upper limit and the QoS lower limit; and
d₃) calculating ratios by dividing the differences of step (d₁) by the difference of step (d₂) to represent the evaluated QoS levels.

4. The method of claim 1, wherein step (e) comprises the steps of:
calculating an average value of the evaluated QoS levels;
detecting respective differences between the average value and the evaluated QoS levels; and
updating the resource utilization rates of the first memory with the respective differences.

5. The method of claim 1, wherein the differences between the target value and the evaluated QoS levels are weighted differences between the target value and the evaluated QoS levels.

6. The method of claim 4, wherein the differences between the average value and the evaluated QoS levels are weighted differences between the average value and the evaluated QoS levels.

7. The method of claim 1, wherein the resource utilization rates are utilization rates of a central processing unit.

8. The method of claim 1, wherein the items stored in the queue are temporal service items for which contention arises among the tasks.

9. The method of claim 1, wherein the items stored in the queue are spatial service items for which request is issued from the tasks.

10. A computer system having a plurality of tasks, comprising:
a queue for holding a plurality of items of the tasks during a time interval;
a first memory for storing resource utilization rates associated respectively with the stored items;
means for executing the items at the associated resource utilization rates respectively; and
adaptive control mechanism for detecting QoS levels of the executed items, evaluating the detected QoS levels of the executed items, storing the evaluated QoS levels in the second memory, and updating the resource utilization rates of the first memory with respective differences between a target value and the evaluated QoS levels; and
decision mechanism for determining, from the evaluated QoS levels, whether the detected QoS levels are converging to said target value or diverging from said target value, replacing the stored items of the queue with new items of the tasks if the evaluated QoS levels are converging to said target value, and causing the previously stored items to be executed again by the executing means if the evaluated QoS levels are diverging from said target value.

11. The computer system of claim 10, further comprising a second memory, and wherein said adaptive control mechanism stores the evaluated QoS levels in said second memory, and said decision mechanism compares a difference between each of the evaluated QoS levels stored in the second memory during a previous time interval and each of the evaluated QoS levels stored in the second memory during a current time interval to a predetermined value, replaces the stored items of the queue with new items of the tasks if the difference is smaller than the predetermined value, and causes the previously stored items to be executed again by the executing means if the difference is greater than the predetermined value.

12. The computer system of claim 10, wherein the adaptive control mechanism detects differences between the detected QoS levels and a QoS lower limit, detects a difference between a QoS upper limit and the QoS lower limit, and calculates ratios by dividing the detected differences by the detected difference to represent the evaluated QoS levels.

13. The computer system of claim 10, wherein the adaptive control mechanism calculates an average value of the evaluated QoS levels, detects respective differences between the average value and the evaluated QoS levels, and updates the resource utilization rates of the first memory with the respective differences.

14. The computer system of claim 10, wherein the differences between the target value and the evaluated QoS levels are weighted differences between the target value and the evaluated QoS levels.

15. The computer system of claim 13, wherein the differences between the average value and the evaluated QoS levels are weighted differences between the average value and the evaluated QoS levels.

16. The computer system of claim 10, wherein the resource utilization rates are utilization rates of a central processing unit.

17. The computer system of claim 10, wherein the items stored in the queue are temporal service items for which contention arises among the tasks.

18. The computer system of claim 10, wherein the items stored in the queue are spatial service items for which request is issued from the tasks.

19. A computer-readable storage medium containing a program for controlling QoS levels of a plurality of tasks, the program comprising the steps:
a) during a time interval, storing items of the tasks in a queue;
b) executing the items at respective resource utilization rates;
c) detecting QoS levels of the executed items;
d) evaluating the detected QoS levels of the executed items;
e) updating the resource utilization rates with respective differences between a target value and the evaluated QoS levels;
f) determining, from the evaluated QoS levels, whether the detected QoS levels are converging to said target value or diverging from said target value; and
g) during a subsequent time interval, replacing the previously stored items of the queue with new items of the tasks and repeating steps (b) to (f) on the new items if the QoS levels are converging to said target value, and repeating steps (b) to (f) on the previously stored items if QoS levels are diverging from said target value.

20. The computer-readable storage medium of claim 19, wherein step (f) comprises the steps of:
detecting a difference between each of the evaluated QoS levels obtained during a previous time interval and each of the evaluated QoS levels obtained during a most recent time interval; and
comparing the detected difference to a predetermined value, wherein step (g) comprises the steps of:
during said subsequent time interval, replacing the previously stored items of the queue with new items of the tasks and repeating steps (b) to (f) on the new items if the difference is smaller than the predetermined value, and repeating steps (b) to (f) on the previously stored items if the difference is greater than the predetermined value.

21. The computer-readable storage medium of claim 19, wherein step (d) comprises the steps of:
d₁) detecting differences between the detected QoS levels and a QoS lower limit;
d₂) detecting a difference between a QoS upper limit and the QoS lower limit; and
d₃) calculating ratios by dividing the differences of step (d₁) by the difference of step (d₂) to represent the evaluated QoS levels.

22. The computer-readable storage medium of claim 19, wherein step (e) comprises the steps of:
calculating an average value of the evaluated QoS levels;
detecting respective differences between the average value and the evaluated QoS levels; and
updating the resource utilization rates of the first memory with the respective differences.

23. The computer-readable storage medium of claim 19, wherein the differences between the target value and the evaluated QoS levels are weighted differences between the target value and the evaluated QoS levels.

24. The computer-readable storage medium of claim 22, wherein the differences between the average value and the evaluated QoS levels are weighted differences between the average value and the evaluated QoS levels.

25. The computer-readable storage medium of claim 19, wherein the resource utilization rates are utilization rates of a central processing unit.

26. The computer-readable storage medium of claim 19, wherein the items stored in the queue are temporal service items for which contention arises among the tasks.

27. The computer-readable storage medium of claim 19, wherein the items stored in the queue are spatial service items for which request is issued from the tasks.
